(19) United States
(12) Patent Application Publication
(10) Pub. No.: US 2008/0242826 A1
(43) Pub. Date: Oct. 2, 2008

(54) Multiple Quartenary Polysiloxanes

(76) Inventor: Bernard Danner, Riedisheim (FR)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/575,153

(22) PCT Filed: Oct. 4, 2004
(86) PCT No.: PCT/IB04/03220

§ 371 Date: Apr. 6, 2006

(30) Foreign Application Priority Data
Oct. 7, 2003 (EP) 03022449.7

(51) Int. Cl. C08G 77/14

(52) U.S. Cl. 528/38

(57) ABSTRACT

The present invention concerns polysiloxanes having plural quaternary ammonium groups, their preparation and their use as softeners in the textile industry. Materials treated therewith exhibit a surprisingly high shear stability, an excellent, pleasant softness and improved sewability.

The present invention concerns polysiloxanes having plural quaternary ammonium groups, their preparation and their use as softeners in the textile industry.

There is extensive literature about silicone compounds having quaternary ammonium groups. These compounds are used for example as softeners in the textile industry, as surface-treating agents, as thickeners or in the cosmetic industry. WO 03/035721 A1 for example discloses silicone compounds which contain quaternary ammonium groups and methods for their preparation.

There nevertheless continues to be a demand in the textile industry for softening substances possessing better shear stability and better hand than prior art compounds.

It has now been found that certain polysiloxanes having plural quaternary ammonium groups have surprisingly good properties when used as softeners in the textile industry and lead to products having high shearing stability and good hand.

The invention accordingly provides multiply quaternized polysiloxanes of the formula (S1)

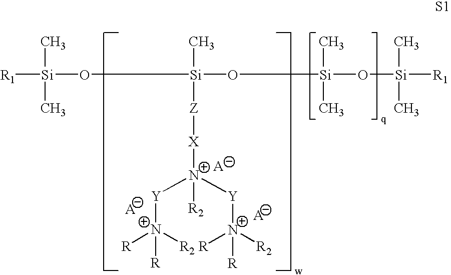

where
the sum total of (q+w) has a range of 10-1500, preferably of 15-600, and the q/w ratio has a range of 5-600, preferably of 10-400,
R is C₁-C₄-alkyl, linear or branched,
R₁ is hydrogen, C₁-C₃-alkyl or C₁-C₃-alkoxy,
R₂ is C₁-C₇-alkyl or benzyl,
X is a direct bond
or

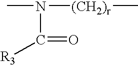

where
r is 1-4 and
R₃ is C₁-C₇alkyl or —NH—C₁-C₇alkyl,
or

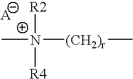

where
R₂ and r are each as defined above,
R₄ is C₁-C₃-alkyl,
or

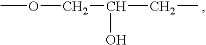

### Y is

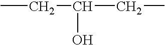

or

—(CH₂)ₓ—,

where
x is 1-4,
Z is C₂-C₄-alkylene, linear or branched and
A⁻ is CH₃OSO₃⁻, chloride, bromide, iodide or tosylsulfate⁻,
or of the formula (S2)

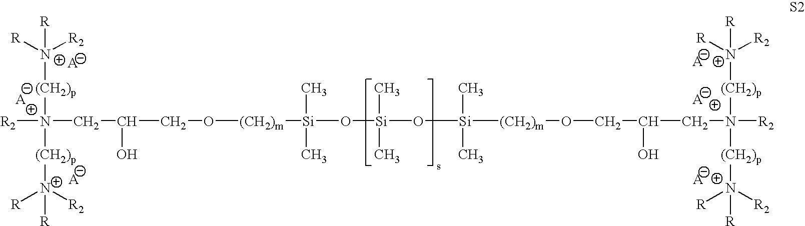

where
R, R₂ and A⁻ have the same meaning as in formula (S1),
m is 1-4,
p is 1-4, and
s is 5-1500, preferably 10-600.

Preference is given to compounds wherein

the sum total of (q+w) has a range of 15-600 and the q/w ratio has a range of 10-400,
R is methyl, ethyl or propyl,
R₁ is H, methyl, —OCH₃ or —OC₂H₅,
R₂ is methyl or benzyl,
R₃ is methyl or —NH—C₄H₉,
R₄ is methyl,
A⁻ is CH₃OSO₃⁻ or chloride,
Z is C₃-alkylene, linear or branched,
m is 3,
p is 3,
s is 10-600,
r is 2, and
x is 3.

Very particularly suitable polysiloxanes have the following structural units:

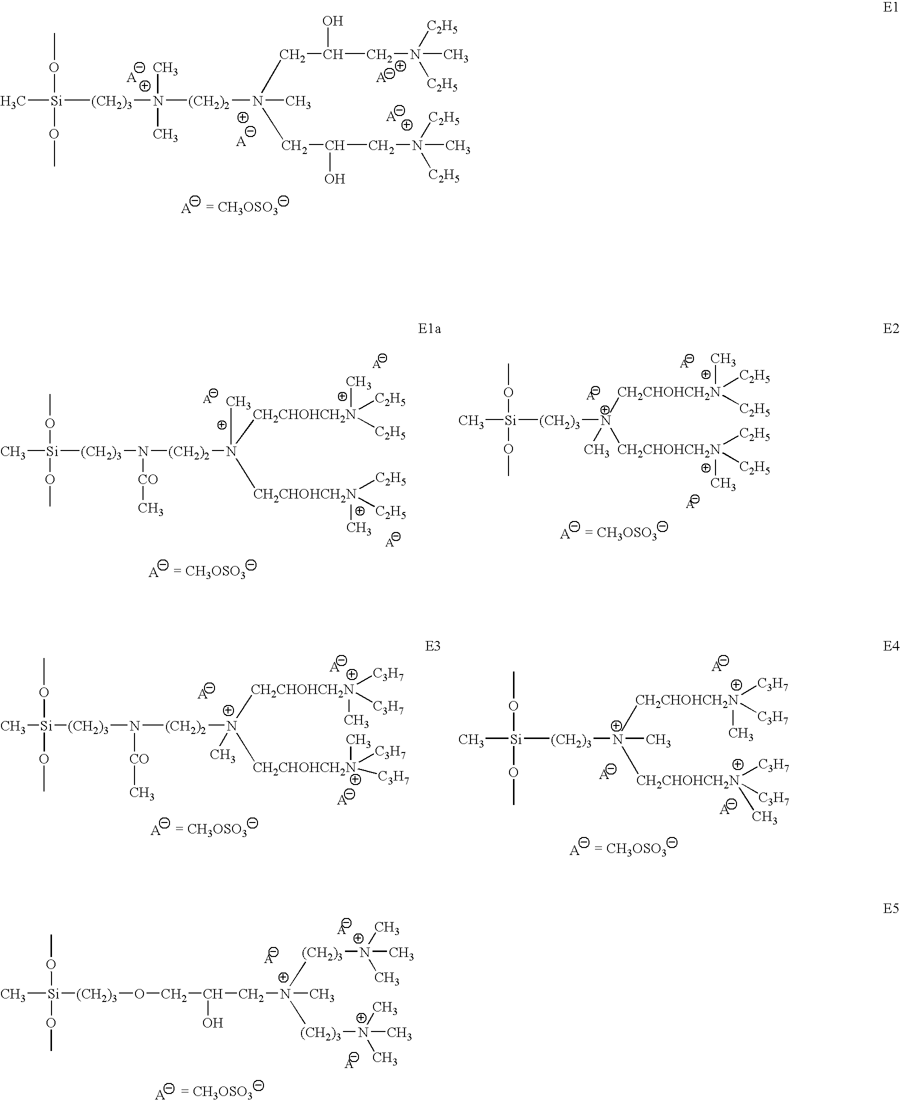

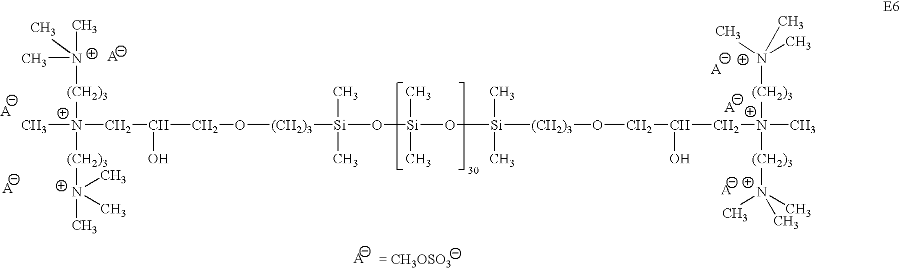

The invention further provides for the preparation of the aforementioned polysiloxanes.

The formula (S1) compounds in which Y is

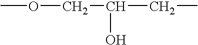

### and X is

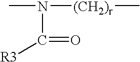

can be prepared by reaction of 3-(2-aminoalkylamino)alkyldialkoxymethylsilane with glycidyldialkylamine (preparable by reaction of dialkylamine with epichlorohydrin) to form the corresponding silane and subsequent reaction of the resultant silanes with a) polydimethylsiloxanediol or with octamethylcyclotetrasiloxane, and with b) tetraalkyl- or arylalkyl-ammonium hydroxide (for example benzyltrimethyl-, tetramethyl- or tetrabutyl-ammonium hydroxide) to form polysiloxanes with subsequent quaternization to the multiply quaternized siloxanes. Preferred starting substances are 3-(2-aminoethyl-amino)propyldimethoxymethylsilane, 3-(2-aminoethylamino)propyl-diethoxymethylsilane and glycidyidimethylamine, glycidyidiethylamine and glycidyidipropylamine. Examples thereof are the end products E1a and E3.

Quaternization can be effected using conventional quaternizing agents of the kind known per se for quaternizing tertiary amino groups, examples being alkyl halides or dialkyl sulphates, for example dimethyl sulphate, diethyl sulphate, or methyl chloride, ethyl chloride, methyl bromide, ethyl bromide or benzyl chloride. It is advantageous to use benzyl chloride or preferably a dialkyl sulphate for this purpose. To each particular quaternary ammonium ion formed the corresponding counterion (particularly chloride or alkylsulphate ion) is formed. Dimethyl sulfate is particularly preferred.

The formula (S1) polysiloxanes in which Y is

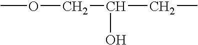

and X is a direct bond can be prepared by the reaction of 3-aminoalkyldialkoxy-methylsilane with glycidyldialkylamine (preparable by reaction of dialkylamine with epichlorohydrin) to form the corresponding silane, and subsequent reaction of the resultant silanes with a) polydimethylsiloxanediol or with octamethylcyclotetrasiloxane, and with b) tetraalkyl- or arylalkyl-ammonium hydroxide (for example benzyltrimethyl-, tetramethyl- or tetrabutyl-ammonium hydroxide) to form polysiloxanes with subsequent quaternization to the multiply quaternized siloxanes.

Preferred starting substances are 3-aminopropyldiethoxymethylsilane, 3-aminopropyl-dimethoxymethylsilane and glycidyidimethylamine, glycidyldiethylamine and glycidyidipropylamine. Examples thereof are the end products E2 and E4.

The formula (S1) polysiloxanes in which Y is —(CH₂)ₓ— and X is

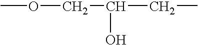

can be prepared by reaction of N′-[3-(dialkylamino)alkyl]-N,N-dialkylalkane-1,3-diamine with dialkoxy(3-glycidyloxyalkyl)methylsilane and subsequent reaction with polydimethylsiloxanediol or with octamethylcyclotetrasiloxane with subsequent quaternization.

Preferred starting substances are N′-[3-(dimethylamino)propyl]-N,N-dimethylpropane-1,3-diamine, diethoxy(3-glycidyloxypropyl)methylsilane and dimethoxy(3-glycidyloxypropyl)methylsilane. As an example thereof there may be mentioned the end product E5.

The compounds of the formula (S2) can be prepared for example by reaction of octamethylcyclotetrasiloxane with 1,1,3,3-tetraalkyldisiloxane, preferably 1,1,3,3-tetramethyldisiloxane, reaction of the reaction product with an allyl glycidyl ether and a hydrosilylation catalyst, reaction of this reaction product with N,N,N′,N′-tetraalkyldialkylenetriamine, preferably N,N,N′,N′-tetramethyldipropylenetriamine, to form the polysiloxane, and subsequent quaternization. As an example thereof there may be mentioned the end product E6.

Instead of octamethylcyclotetrasiloxane it is also possible to use penta- or hexamethyl-cyclotetrasiloxane or mixtures thereof.

The compounds according to the invention are very useful as softeners in the treatment of textiles, specifically for cotton and polyester. The materials treated therewith exhibit a surprisingly high shearing stability, an excellent, pleasant softness and improved sewability. The products can also be used in the form of microemulsions.

### EXAMPLES

The examples which follow illustrate the invention. Parts are by weight.

### A. Silicone Oils

### 1. Preparation of Silanes (I) and (II)

### 1.1 Preparation of Glycidyldiethylamine

298.00 parts of diethylamine are mixed with 12.25 parts of water. 377.60 parts of epichlorohydrin are then added dropwise at 20° C. within 10 hours with stirring. This is followed by further stirring at 20° C. for 10 hours before 506.7 parts of 30% by weight aqueous sodium hydroxide solution are added dropwise. The stirrer is switched off after 3 hours (15-20° C.). An organic phase forms (501.5 parts) and is separated off. It consists of about 384.0 parts of glycidyidiethylamine, 60.0 parts of N,N,N′,N′-tetraethyl-1,3-diamino-2-hydroxypropane, 25.0 parts of water, 24.5 parts of N,N-diethyl-2-hydroxy-3-chloropropaneamine, 1.0 part of sodium chloride and 7.0 parts of 3-dimethylamino-2-hydroxy-1-propanol.

### 1.2 Preparation of Silane (I)

309.00 parts of 3-(2-aminoethylamino)propyldimethoxymethylsilane are mixed with 505.40 parts of the freshly prepared organic phase of 1.1 with stirring and heated to 60° C. A slightly exothermic reaction takes place. The exothermic reaction ceases after about 2 hours and the batch is left to react further at 60° C. for 4 hours. It is then cooled down to room temperature. Glycidyl groups are no longer titratable. An alkylation of the primary amino group has taken place. 814.4 parts are obtained of a silane mixture (I) having the following main components:

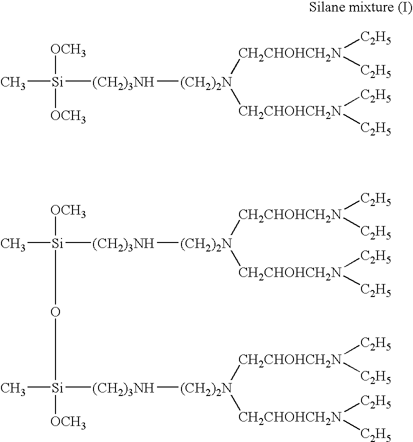

1.3 Preparation of silane (II)

286.50 parts of 3-aminopropyldiethoxymethylsilane are mixed together with 505.40 parts of the freshly prepared organic phase at room temperature with stirring and heated to 60° C. An exothermic reaction takes place, the temperature being held at 60° C. by cooling. As soon as the exothermic reaction is over, the batch is allowed to react further at 60° C. for 4 hours and is then cooled down to room temperature. Glycidyl groups are no longer titratable. An alkylation of the primary amino groups of the silane has taken place. 791.9 parts are obtained of a silane mixture (II) having the following main components:

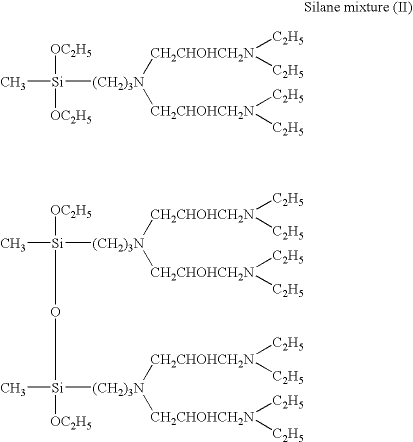

### 2. Preparation of Silanes (III) and (IV)

### 2.1 Preparation of Glycidyldipropylamine

404.0 parts of dipropylamine are mixed with 12.0 parts of water and cooled down to 20° C. 370.0 parts of epichlorohydrin are then added dropwise within 60 minutes while the temperature is held between 18 and 20° C. After a subsequent-stirring time of about 20 hours at 20° C. 673.4 parts of sodium methoxide-methanol solution, 30%, are added dropwise in 60 minutes. Immediately a sodium chloride precipitate forms as a result of the formation of the glycidyl compound. After the sodium chloride has been removed by filtration first methanol and then the resultant glycidyidipropylamine are distilled off. 470 g of glycidyidipropylamine having an equivalent weight of 161.8 (97% pure) are obtained between 65 and 80° C. at 8 to 14 mbar (yield: 72.5%).

2.2 Preparation of silane (III)

309.00 parts of 3-(2-aminoethylamino)propyldimethoxymethylsilane are reacted with 485.4 parts of glycidyidipropylamine, prepared as per 2.1, exactly as described under 1.2 to obtain 794.4 parts of silane (III) of the following structure:

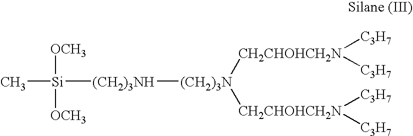

### 2.3 Preparation of Silane (IV)

286.50 parts of 3-aminopropyldiethoxymethylsilane are reacted with 485.4 parts of glycidyidipropylamine, prepared as per 2.1, exactly as described under 1.2, to obtain 771.9 parts of silane (IV) of the following structure:

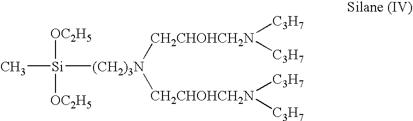

### 3. Preparation of Silane (V)

187.0 parts of N′-[3-(dimethylamino)propyl]-N,N-dimethylpropane-1,3-diamine are heated to 80° C. 248.0 parts of diethoxy(3-glycidyloxypropyl)methylsilane are then added dropwise while the temperature is held at 80° C. After the glycidyl has been added, the reaction is allowed to proceed at 130° C. for a further 4 hours, to obtain 435.0 parts of silane (V) of the following structure:

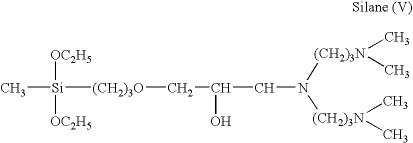

### 4. Preparation of Polysiloxane (I)

691.0 parts of polydimethylsiloxanediol (viscosity 80 cp=0.08 Pas) (Polydimethylsiloxanediol L), 28.2 parts of silane (I) (reaction mixture 1) and also 5.5 parts of a 40% solution of benzyltrimethylammonium hydroxide in methanol are mixed together and heated to 80° C. with stirring. After 3 hours at 80° C. the batch is evacuated down to about 200 mbar residual pressure and heated to 150° C. at this pressure in the course of 60 minutes. This is followed by evacuation to about 50 mbar residual pressure and, after 60 minutes under these conditions, cooling to room temperature under constant residual pressure (50 mbar) to obtain about 707.0 parts of polysiloxane (I) (viscosity 2660 cp 2.66 Pas) and 15.0 parts of distillate.

### 5. Preparation of Polysiloxane (II)

691.0 parts of polydimethylsiloxanediol (viscosity 80 cp=0.08 Pas) (Polydimethylsiloxanediol L), 38.73 parts of silane (II) (reaction mixture II) and also 5.4 parts of a 40% solution of benzyltrimethylammonium hydroxide in methanol are mixed together and heated to 80° C. with stirring. After 3 hours at 80° C. the batch is evacuated down to about 200 mbar residual pressure and heated to 150° C. at this pressure in the course of 60 minutes. This is followed by evacuation to 50 mbar residual pressure and distillation for 60 minutes at this pressure and at 150° C., to obtain about 15.8 parts of distillate. After cooling to room temperature under vacuum about 715.4 parts of polysiloxane (II (viscosity 900 cp=0.9 Pas) are obtained.

### 6. Preparation of Polysiloxane (III)

691.0 parts of polydimethylsiloxanediol, 55.1 parts of silane (III) and 3.2 parts of a 40% solution of benzyltrimethylammonium hydroxide in methanol are heated to 80° C. in a closed vessel. After 4 hours at 80° C. the pressure reactor is equipped with a distillation bridge and evacuated to 200 mbar residual pressure. As soon as this pressure is obtained, the reactor is heated to 150° C. in the course of 60 minutes. The residual pressure is then lowered to 50 mbar with continued stirring at 150° C. for 1 hours. This is followed by cooling to room temperature at 50 mbar residual pressure to obtain about 728.0 parts of polysiloxane (III) having a viscosity of 2150 cp=2.15 Pas.

### 7. Preparation of Polysiloxane (IV)

691.0 parts of Polydimethylsiloxanediol L, 38.0 parts of silane (IV) and 0.7 part of a 40% solution of benzyltrimethylammonium hydroxide in methanol are heated to 80° C. and left to react at this temperature for 3 hours. This is followed by evacuation to 900 mbar residual pressure and heating to 150° C. at this pressure in the course of 60 minutes. This is followed by full evacuation (50 mbar residual pressure) before the temperature is held at 150° C. for 30 minutes. The reactor is then cooled down to room temperature, depressurized to atmospheric with nitrogen and emptied to obtain 694.1 parts of polysiloxane (IV) having a viscosity of 1760 cp=1.76 Pas.

### 8. Preparation of Polysiloxane (V)

The procedure for polysiloxane (IV) is repeated except that 32.1 parts of silane (V) are used instead of 38.0 parts of silane (IV). 696.2 parts of polysiloxane (V) having a viscosity of 1200 cp=1.2 Pas are obtained.

### 9. Preparation of Polysiloxane (VI)

419.3 parts of octamethylcyclotetrasiloxane (D4) and 25.3 parts of 1,1,3,3-tetramethyldisiloxane are heated to 80° C. together with 0.43 part of trifluoromethanesulphonic acid. After 4 hours at 80° C. the batch is admixed with 0.43 part of magnesium oxide, evacuated to 50 mbar residual pressure and heated to 150° C. under these conditions. After 30 minutes at 150° C. and 50 mbar the batch is cooled down to room temperature under vacuum and discharged through a paper filter to obtain 405.7 parts of an H-terminated polydimethylsiloxane. This product is then heated back up to 80° C. under nitrogen. As soon as 80° C. is attained, 35 ml of a 3% (based on platinum) of a platinum-cyclovinylmethylsiloxane complex (in cyclic methylvinylsiloxanes) (hydrosilylation catalyst) are added before 42.6 parts of allyl glycidyl ether are added dropwise in the course of about 60 minutes. As soon as the Si—H groups have reacted (if not, some more catalyst is added), the batch is heated to 100° C., evacuated to 50 mbar residual pressure and, after 60 minutes at 100° C., cooled down to room temperature 50 mbar to obtain 443.0 parts of glycidyl-terminated polydimethylsiloxane having an equivalent weight of 1334 (equivalent weight for a glycidyl group). 62.1 parts of N,N,N′,N′-tetramethyldipropylenetriamine are then added and heated to 130° C. As soon as the glycidyl groups are no longer titratable the batch is cooled down to room temperature to obtain 505.1 parts of polysiloxane (VI) having the following general formula:

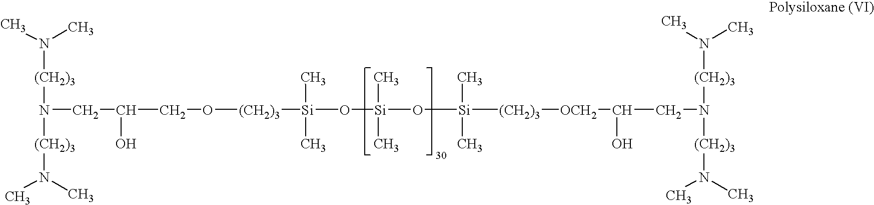

### B. End Products

### 1. Based on Polysiloxane (I)

200.0 parts of polysiloxane (I) are emulsified with 50.0 parts of tridecanol poly-6,5-ethylene glycol (emulsifier 1) and 50.0 parts of water and heated to 40° C. As soon as this temperature is reached, 10.04 parts of dimethyl sulphate are added dropwise. After 6 hours at 40° C. twice 200 parts of water are added followed by 40 parts of hexylene glycol. This is followed by the addition of a further 70 parts of emulsifier (I) and 180 parts of water to obtain 1000.0 parts of a 20% microemulsion of the fully quaternized polysiloxane (I) (end product E1).

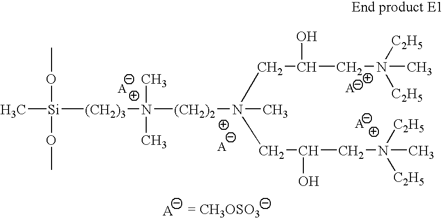

### 2. Based on Polysiloxane (I)

The procedure for end product E₁ is repeated except that only 6.02 parts of dimethyl sulphate are added instead of 10.04 parts and prior to the heating to 40° C. 52.0 parts of water are used instead of 50 parts after the addition of 50 parts of emulsifier (I) and in addition 2.0 parts of dimethyl dicarbonate are added. As soon as CO₂ evolution has taken place, the batch is heated to 40° C. and further processed to obtain 1000.0 parts of a 20% microemulsion of a polysiloxane E1a having the following functional groups:

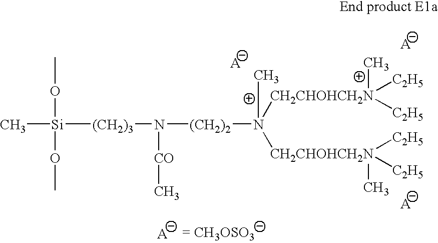

### 3. Based on Polysiloxane (II)

200.0 parts of polysiloxane (II) are mixed with 40.0 parts of hexylene glycol and heated to 40° C. 8.86 parts of dimethyl sulphate are then added dropwise and reacted at 40° C. for 6 hours. This is followed by the addition of 115.0 parts of emulsifier (I) and—as soon as a homogeneous mixture is present—of 390.0 parts of water at 60° C. to form a microemulsion, which is cooled to room temperature by addition of 247.0 parts of water and by external cooling to obtain about 1000 parts of microemulsion (E2). The siloxane of E2 contains the following functional groups:

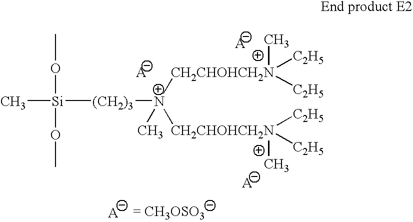

### 4. Based on Polysiloxane (II)

The procedure for E2 is repeated with the following amounts and reactants:

| | | |
|---|---|---|
| Polysiloxane (III) | 200.0 | parts |
| Water (1) | 52.0 | parts |
| Emulsifier (I) (1) | 50.0 | parts |
| Dimethyl dicarbonate | 3.8 | parts |
| Dimethyl sulphate | 10.8 | parts |
| Water (2) | 400.0 | parts |
| Hexylene glycol | 40 | parts |
| Emulsifier (I) (2) | 70 | parts |
| Water (3) | 174 | parts |

About 1000.0 parts of emulsion E3 are obtained. The emulsified polysiloxane has the following functional groups:

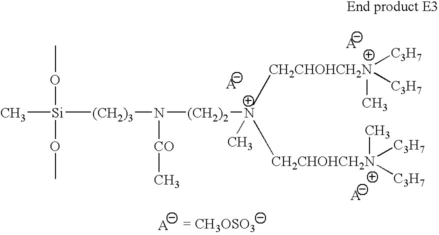

### 5. Based on Polysiloxane (IV)

The procedure for E3 is repeated with the following amounts and reactants:

| | |
|---|---|
| Polysiloxane (IV) | 200.0 parts |
| Hexylene glycol | 40.0 parts |
| Dimethyl sulphate | 8.1 parts |
| Emulsifier (I) | 115.0 parts |
| Water (1) | 390.0 parts |
| Water (2) | 247.0 parts |

About 1000.0 parts of emulsion E4 are obtained. The emulsified polysiloxane has the following functional groups:

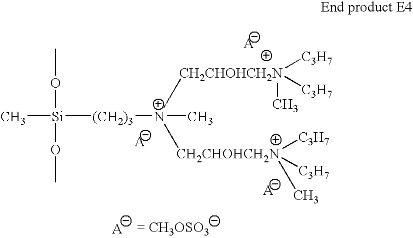

### 6. Based on Polysiloxane (V)

The procedure for E4 is repeated using polysiloxane (V) in place of (IV). About 1000.0 g of end product E5 are obtained. The emulsified polysiloxane has the following functional groups:

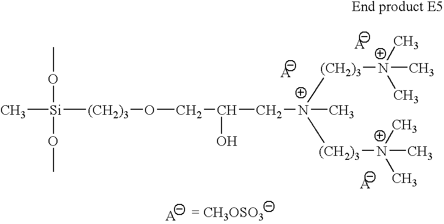

### 7. Based on Polysiloxane (VI)

200.0 parts of polysiloxane (VI) are mixed with 100.0 parts of hexylene glycol and then reacted with 49.7 parts of dimethyl sulphate at 40° C. for 4 hours. 751 parts of water are added to obtain 1000.0 parts of end product E6. The self-dispersed polysiloxane has the following structure:

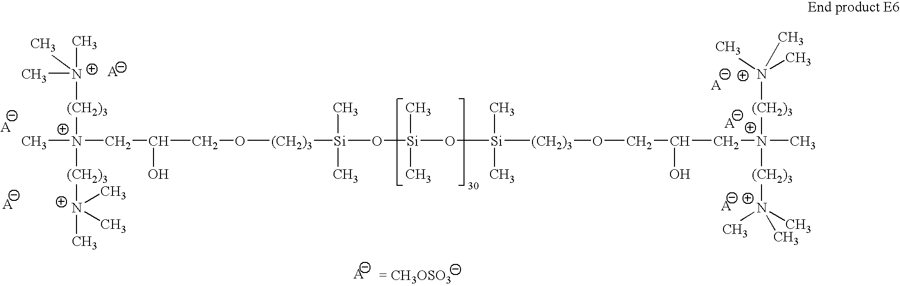

### APPLICATION EXAMPLES

1) A textile substrate is padded at room temperature to a 100% dry weight increase with an aqueous liquor which contains a g/l of the products E₁ to E₆, b g/l of aqueous 50% dimethyloldihydroxyethyleneurea solution and c g/l of magnesium chloride hexahydrate. The padded material is subsequently subjected to a thermal treatment.

| | | | Composition of | | | Thermal treatment | |
|---|---|---|---|---|---|---|---|
| Appl. | Sub- | Prod- | liquor | | | | Total |
| Ex. | strate | uct E | a | b | c | Temp. | duration |
| 1.1 | T₁ | E1 | 20 | 0 | 0 | 140° C. | 80 sec. |
| 1.2 | T₁ | E1a | 40 | 0 | 0 | 140° C. | 80 sec. |
| 1.3 | T₂ | E2 | 20 | 100 | 15 | 175° C. | 90 sec. |
| 1.4 | T₂ | E2 | 40 | 100 | 15 | 175° C. | 90 sec. |
| 1.5 | T₃ | E2 | 30 | 0 | 0 | 140° C. | 80 sec. |
| 1.6 | T₄ | E3 | 30 | 0 | 0 | 130° C. | 80 sec. |
| 1.7 | T₅ | E4 | 30 | 0 | 0 | 140° C. | 90 sec. |
| 1.8 | T₆ | E5 | 30 | 0 | 0 | 140° C. | 90 sec. |
| 1.9 | T₂ | E6 | 30 | 100 | 15 | 175° C. | 90 sec. |

T₁ cotton tricot, interlock, bleached, unbrightened
T₂ cotton tricot, interlock, bleached
T₃ polyester/cotton (50/50) intimate blend, tricot, dyed with reactive and disperse dyes
T₄ polyester fabric, dyed with disperse dyes
T₅ cotton gabardine, dyed with reactive dyes
T₆ cotton gabardine, bleached, mercerized

2. 1 kg of the substrate to be finished (tubular textile material, cotton single jersey, blue) is treated with finishing agents (products E1 to E7) on a Mathis (Switzerland) laboratory jet at 40° C. and a liquor ratio of 8:1. Liquor circulation rate is 60 l/min and treatment time is 20 minutes. The water has 10° of German hardness (according to German Industrial Specification DIN 53905) and a pH of 5 (set with sodium carbonate or acetic acid). After treatment, the substrate is whizzed and dried at 140° C. for 90 seconds.

The textiles treated as per 1) and 2) exhibit excellent, pleasant softness. Sewability is distinctly improved.

1. A multiply quaternized polysiloxane of the formula (S1) 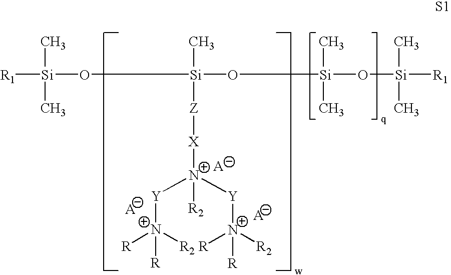
where
the sum total of (q+w) has a range of 10-1500 and the q/w ratio has a range of 5-600,
R is C₁-C₄-alkyl, linear or branched,
R₁ is hydrogen, C₁-C₃-alkyl or C₁-C₃-alkoxy,
R₂ is C₁-C₇-alkyl or benzyl,
X is a direct bond
or 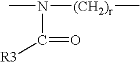
where
r is 1-4 and
R₃ is C₁-C₇-alkyl or —NH—C₁-C₇-alkyl,
or 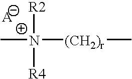
where
R₂ and r are each as defined above,
R₄ is C₁-C₃-alkyl,
or 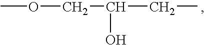
Y is 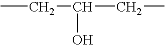
or
—(CH₂)ₓ—,
where
x is 1-4,
Z is C₂-C₄-alkylene, linear or branched and
A⁻ is CH₃OSO₃⁻, chloride, bromide, iodide or tosylsulfate⁻,
or of the formula (S2) 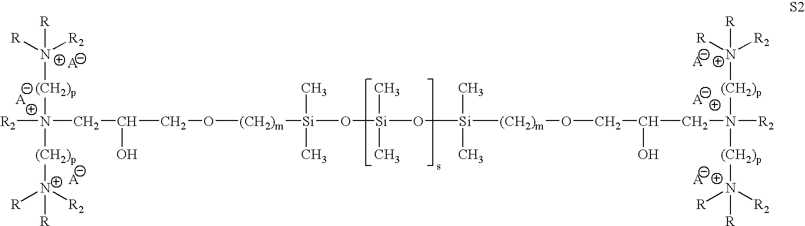
where
R, R₂ and A⁻ have the same meaning as in formula (S1),
m is 1-4,
p is 1-4, and
s is 5-1500.

2. A multiply quaternized polysiloxane according to claim 1 wherein
the sum total of (q+w) has a range of 15-600 and the q/w ratio has a range of 10-400,
R is methyl, ethyl or propyl,
R₁ is H, methyl, —OCH₃ or —OC₂H₅,
R₂ is methyl or benzyl,
R₃ is methyl or —NH—C₄H₉,
R₄ is methyl,
Z is C₃-alkylene, linear or branched,
A⁻ is CH₃OSO₃⁻ or chloride,
m is 3,
p is 3,
s is 10-600,
r is 2, and
x is 3.

3. A multiply quaternized polysiloxane according to claim 1 having structural units of the formula E1 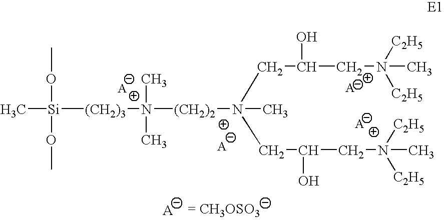
or having structural units of the formula E1a

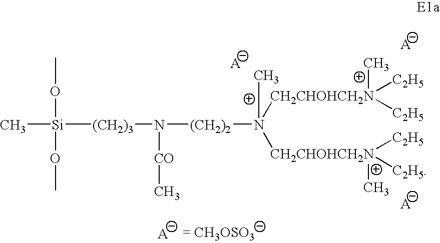

4. A multiply quaternized polysiloxane according to claim 1 having structural units of the formula E2

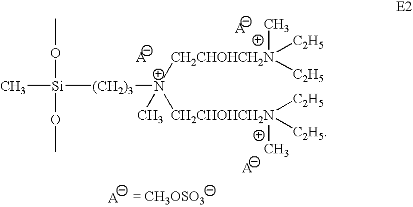

5. A multiply quaternized polysiloxane according to claim 1 having structural units of the formula E3

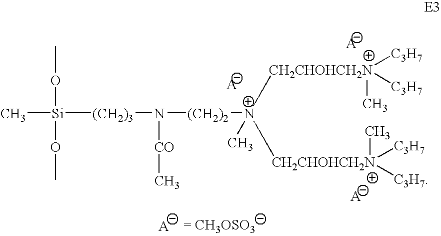

6. A multiply quaternized polysiloxane according to claim 1 having structural units of the formula E4

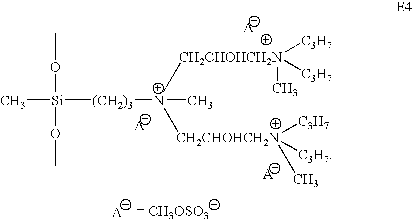

7. A multiply quaternized polysiloxane according to claim 1 having structural units of the formula E5

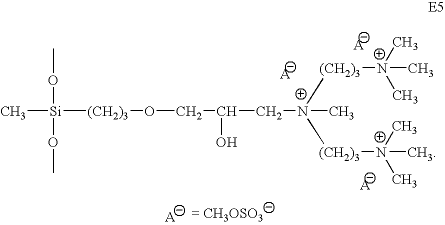

8. A multiply quaternized polysiloxane according to claim 1 of the formula E6

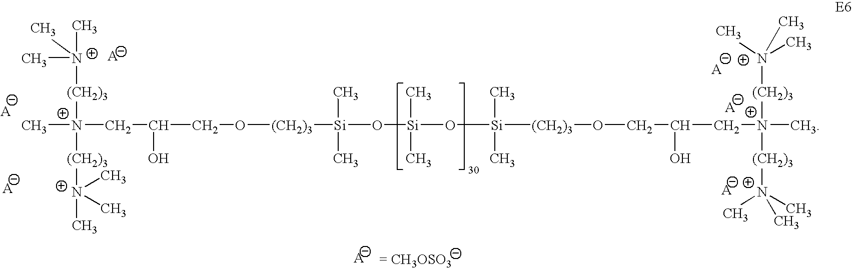

9. A process for preparing a multiply quaternized polysiloxane of the formula (S1) according to claim 1, comprising the steps of:
A) reacting a dialkylamine with epichlorohydrin to form a glycidyidialkylamine,
B) reacting the glycidyldialkylamine with 3-aminoalkyldialkoxymethylsilane or with 3-(2-aminoalkylamino)alkyldialkoxymethylsilane to form the silanes,
C) reacting the silanes with polydimethylsiloxanediol or with octamethylcyclotetrasiloxane or with tetraalkyl- or aryltrialkyl-ammonium hydroxide to form polysiloxanes,
and quartenizing the polysiloxane to form the multiple quaternized polysiloxane.

10. A process for preparing a multiply quaternized polysiloxane of the formula (S1) where Y is —(CH₂)ₓ— and X is 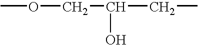
according to claim 1,
comprising the steps of:
A) reacting N′-[3-(dialkylamino)alkyl]-N,N-dialkylalkane-1,3-diamine with dialkoxy(3-glycidyloxyalkyl)methylsilane to form a reaction product,
B) reacting the reaction product from A) with polydimethylsiloxanediol or with octamethylcyclotetrasiloxane, to form the polysiloxane, and guartenizing the polysiloxane.

11. A process for preparing a multiply quaternized polysiloxane of the formula (S2) according to claim 1, comprising the steps of:
A) reacting octaalkylcyclotetrasiloxane with 1,1,3,3-tetraalkyldisiloxane to form a reaction product,
B) reacting the reaction product from A) with an allyl glycidyl ether and a hydrosilylation catalyst to form a second reaction product;
C) reacting the second reaction product from B) with N,N,N′,N′-tetraalkyldialkylenetriamine to form the polysiloxane and quartenizing the polysiloxane.

12. A process for softening a textile substrate comprising the step of applying at least one of the multiply quarternized polysiloxanes according to claim 1 to a textile substrate.

13. A softened textile substrate made in accordance with the process of claim 12.
